(19) United States
(12) Patent Application Publication
(10) Pub. No.: US 2024/0353262 A1
(43) Pub. Date: Oct. 24, 2024

(54) APPARATUS, SYSTEMS, AND METHODS FOR COLORIMETER CALIBRATION

(71) Applicant: Meta Platforms Technologies, LLC, Menlo Park, CA (US)

(72) Inventors: Shubin Zhang, Redmond, WA (US); Difei Qi, Bellevue, WA (US); Mathieu Vedel, San Francisco, CA (US); Erdem Erden, Sammamish, WA (US); Jim Li, Fremont, CA (US)

(21) Appl. No.: 18/305,411

(22) Filed: Apr. 24, 2023

(51) Int. Cl. G01J 3/52; G01J 3/02

(52) U.S. Cl. CPC G01J 3/524; G01J 3/0208

(57) ABSTRACT

A colorimeter calibration apparatus may include a uniform luminance light source that projects light with at least one predetermined characteristic and a reticle holder that is affixed to the uniform luminance light source and that holds a removable reticle through which the light is projected. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a flow diagram of an exemplary method for colorimeter calibration.

FIG. 2 is an illustration of an exemplary reticle used to calibrate colorimeters.

FIG. 3 is an illustration of a cutaway view of an exemplary colorimeter calibration apparatus.

FIG. 4 is an illustration of a side view of an exemplary colorimeter calibration apparatus.

FIG. 5 is an illustration of an exemplary light-emitting diode array for use in a colorimeter calibration apparatus.

FIG. 6 is an illustration of an exemplary light source for use in a colorimeter calibration apparatus.

FIG. 7 is an illustration of an exemplary colorimeter calibration apparatus being calibrated via a spectroradiometer.

FIG. 8 is an additional illustration of an exemplary colorimeter calibration apparatus.

FIG. 9 is an illustration of an exemplary artificial reality headset and glasses that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

Colorimeters are commonly used to calibrate all kinds of displays, from televisions to artificial reality (AR) devices. However, to be effective at calibrating displays, a colorimeter must itself first be calibrated accurately. Inaccurate colorimeter calibration can lead to inaccurate color balance and similar issues in displays calibrated by the inaccurate colorimeter. The present disclosure is generally directed an apparatus for calibrating colorimeters using a series of openings within a customized reticle in front of a uniform luminance light source, which mimics an AR display. By using this approach, the systems described herein are able to avoid the need for a standalone reference instrument and golden display, leading to reduced errors and better-calibrated displays in end-users' hands compared to alternative approaches.

In some embodiments, the systems described herein may improve the functioning of a computing device and/or display device by improving the calibration of the device and/or devices calibrated by the device. Additionally, the systems described herein may improve the fields of contrast calibration and/or AR by calibrating colorimeters with increased accuracy and efficiency, thus improving the calibration of AR displays and/or other displays calibrated by the colorimeters.

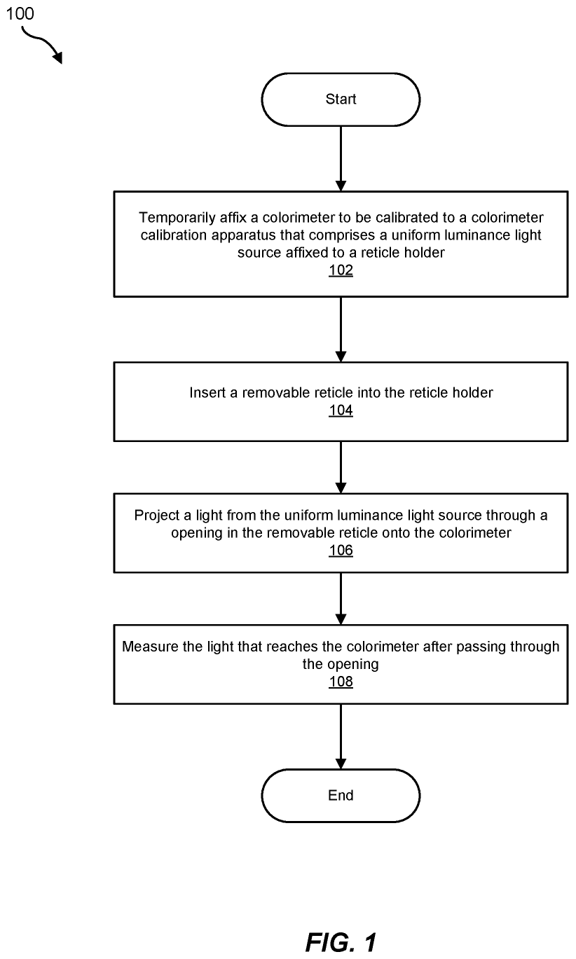

In some embodiments, the systems described herein may be temporarily affixed to a colorimeter that is being calibrated. FIG. 1 is a flow diagram of an exemplary method 100 for colorimeter calibration. Step 102 may include temporarily affixing a colorimeter to be calibrated to a colorimeter calibration apparatus that includes a uniform luminance light source affixed to a reticle holder.

The term colorimeter may generally refer to any device that measures energy readings on the visible spectrum to calibrate output devices. For example, a colorimeter may use photodetectors such as silicon photodiodes to measure the light output of a display device in various wavelengths. In one embodiment, a colorimeter may measure the output of blue, red, green, and white light from a display device. In some examples, a colorimeter may be used to calibrate displays on computing devices such as laptops, phones, and/or AR headsets. In some embodiments, a colorimeter may require calibration in order to accurately interpret data. A colorimeter that is not accurately calibrated may give inaccurate results. For example, if a colorimeter is inaccurately calibrated such that it interprets red light with a blue tint as pure red light, any display device that is calibrated with that colorimeter will display shades of red inaccurately. Because of this, the more accurately a colorimeter can be calibrated, the more effective the colorimeter will be at calibrating display devices.

The term colorimeter calibration apparatus may generally refer to any apparatus, device, and/or system that calibrates colorimeters by projecting light onto a colorimeter and measuring the result. As will be described in greater detail below, a colorimeter calibration apparatus may include a light source, a reticle holder configured to hold at least one removable reticle (e.g., of a series of removable reticles), a lens, and/or a colorimeter holder.

The term uniform luminance light source generally refers to any apparatus that projects light with a uniform (i.e., unvarying) luminance. In some embodiments, a uniform luminance light source may include an integrating sphere light source. The term integrating sphere light source generally refers to any optical component with a hollow spherical or nearly spherical interior that is coated with a diffuse reflective white coating. In some embodiments, an integrating sphere light source may include entry and exit openings in the sphere to allow light to enter and exit, respectively. In one embodiment, an integrating sphere light source may produce bright, diffuse white light.

A colorimeter may be temporarily affixed to a colorimeter calibration apparatus in any of a variety of ways. For example, a colorimeter may be placed on a shelf, held in a clamp, placed into a slot, or temporarily affixed in any other appropriate way. In some embodiments, a colorimeter calibration apparatus may temporarily affix a colorimeter such that each colorimeter temporarily affixed to the colorimeter calibration apparatus is placed in the exact same position and location relative to the rest of the apparatus and thus the apparatus does not need to be adjusted (e.g., by moving lenses, etc.) in between colorimeters.

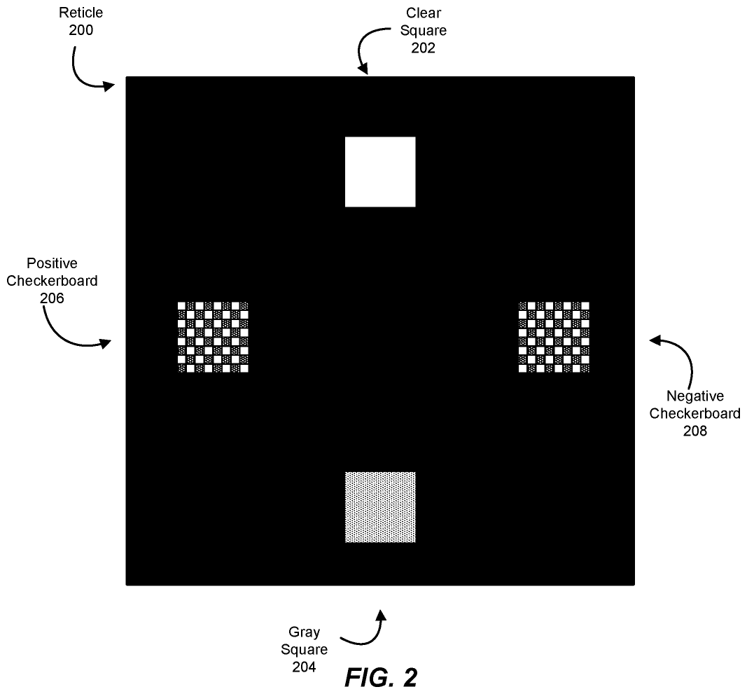

Step 104 may include inserting a removable reticle into the reticle holder. The term reticle may generally refer to any apparatus that includes one or more openings or apertures through which light passes. In some embodiments, openings in a reticle may have a pattern and/or color, also known as a reticle image. For example, a reticle may have an opening with a checkerboard pattern of alternating grey and white squares. In some embodiments, a reticle may include multiple openings. For example, a reticle may include four openings with different patterns. In one example, as illustrated in FIG. 2, a reticle 200 may have four openings: a clear square 202, a positive checkerboard 206 of alternating light and dark checkers (e.g., grey and white squares) with a light checker in the upper left, a negative checkerboard 208 that is the inverse of positive checkerboard 206, and/or a grey square 204 with an optical transmission identical to that of the dark checkers in positive checkerboard 206. In one embodiment, reticle 200 may be designed with rotational symmetry such that reticle 200 can be placed into a reticle holder into any of four different orientations, each of which cause light to pass through a different single opening within reticle 200. In some embodiments, light may pass through a reticle image and/or an imaging lens to project the reticle image onto a colorimeter to be calibrated.

The term reticle holder may generally refer to any component of an apparatus that is configured to hold a removable reticle. For example, a reticle holder may be a slot into which a reticle can be placed. In one embodiment, a reticle holder may be configured such that reticle 200 can be placed into the reticle holder in each of four different orientations, enabling light to pass through each of the different openings in reticle 200 depending on the orientation.

Returning to FIG. 1, step 106 may include projecting a light from the uniform luminance light source through an opening in the removable reticle onto the colorimeter. Step 108 may include measuring the light that reaches the colorimeter after passing through the opening.

The systems described herein may project and measure the light in a variety of ways. In some embodiments, the systems described herein may repeat steps 106 and 108 multiple times for each opening in a reticle and/or may repeat steps 104, 106, and 108 multiple times with different reticles.

In some examples, the systems described herein may, after projecting a light of a first color from the uniform luminance light source onto the colorimeter and taking measurements, project a light of a different color from the uniform luminance light source through the opening in the removable reticle onto the colorimeter and measure the light of the different color that reaches the colorimeter after passing through the opening. For example, the systems described herein may project red light from the uniform luminance light source, and measure the red light at the colorimeter after passing through a positive checkerboard pattern. In this embodiment, the systems described herein may repeat this measurement with the grey square, negative checkerboard, and clear square patterns by rotating the removable reticle to align a different opening with the colorimeter (e.g., via rotating the removable reticle ninety degrees) and measuring the light that reaches the colorimeter after passing through the different opening. The systems described herein then may repeat the entire process with green light, then with blue light.

In some examples, the systems described herein may then remove the removable reticle from the reticle holder, insert, into the reticle holder, a new removable reticle with a new opening not found in the previous removable reticle, and measure the light that reaches the colorimeter after passing through the new opening. In one example, the systems described herein may remove the removable reticle and insert a new reticle with the same patterns at a different grey level and repeat the red, green, and blue light measurements with each opening of the new reticle. In one embodiment, the systems described herein may repeat these steps with six removable reticles with different grey levels in the patterns in the openings. For example, the reticles may have grey levels with a contrast ratio of 0.5, 1, 1.5, 2, 2.5, and 3. In some examples, the systems described herein may measure the true source contrast ratio of the patterns in a reticle via the clear square and/or solid grey square patterns.

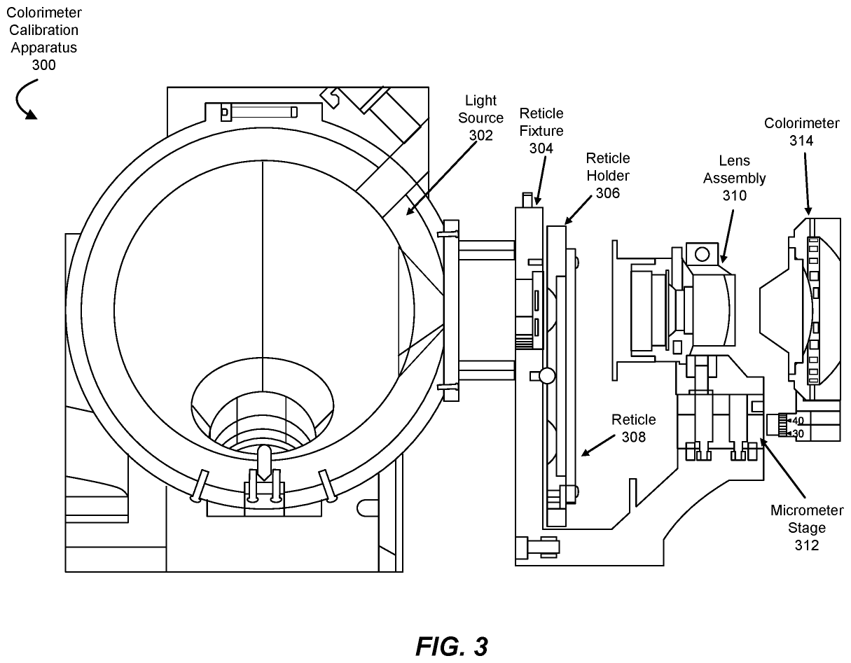

A colorimeter calibration apparatus may be assembled in a variety of ways. In one example, as illustrated in FIG. 3, a colorimeter calibration apparatus may have a light source 302 (e.g., an integrating sphere light source) affixed to a reticle fixture 304. In some embodiments, reticle fixture 304 may include a mounting flange to be mounted on light source 302, a reticle bracket (e.g., reticle holder 306) to hold a removable reticle via magnet, and/or an adjustable lens module to adjust focus. In some embodiments, reticle fixture 304 may be mounted such that light projecting from light source 302 projects through an opening in a reticle 308 temporarily inserted into reticle holder 306. In one embodiment, after passing through the opening in reticle 308, the light may also pass through one or more lenses in a lens assembly 310 that is affixed to the reticle fixture before reaching a colorimeter 314 that is temporarily affixed to colorimeter calibration apparatus 300. In some embodiments, a micrometer stage 312 may aid in affixing colorimeter 314 to colorimeter calibration apparatus 300 in a repeatable manner that requires no or minimal re-positioning of other elements when a colorimeter is removed and replaced with a new colorimeter to be calibrated.

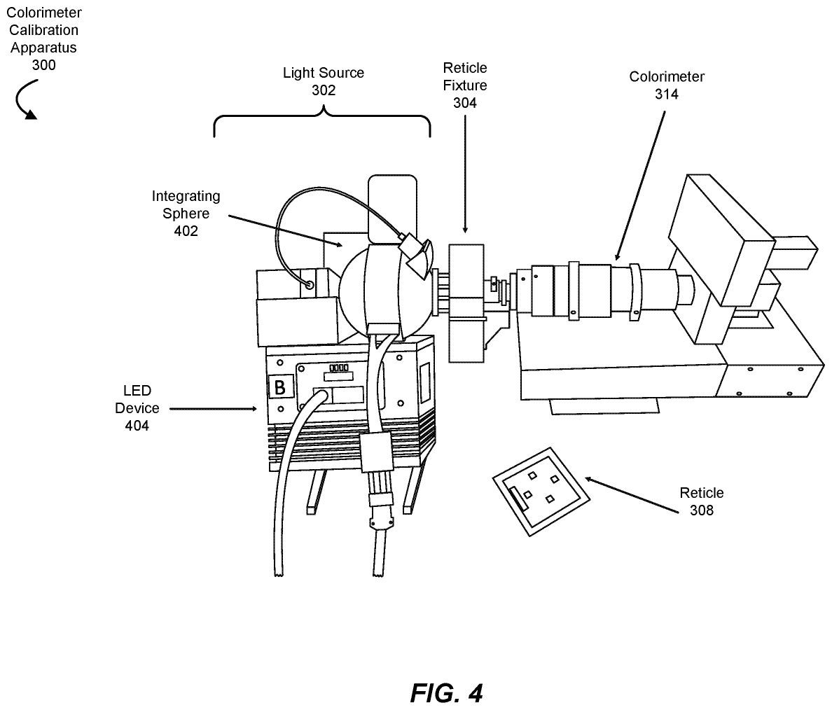

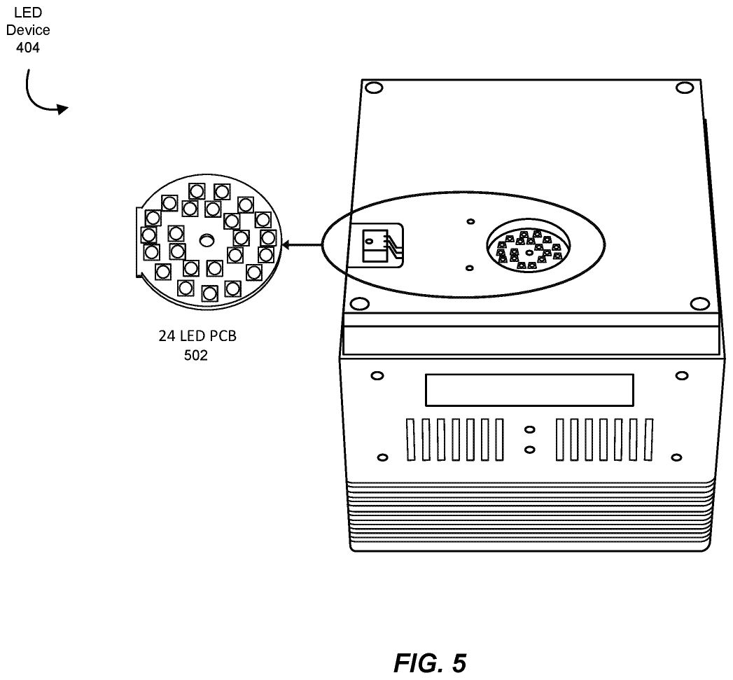

In some embodiments, light source 302 may include an integrated sphere affixed to a light-emitting diode (LED) array that projects light into the integrating sphere. For example, as illustrated in FIG. 4, light source 302 may include an integrating sphere 402 that receives light from an LED device 404, diffuses the light, and projects the light through a reticle (e.g., reticle 308) in reticle fixture 304 to colorimeter 314. In some embodiments, LED device 404 may include a printed circuit board (PCB) with an array of LEDs capable of projecting light of various colors. For example, as illustrated in FIG. 5, LED device 404 may include a 24 LED PCB 502. In some examples, 24 LED PCB 502 may enable LED device 404 to project bright red, green, or blue light into integrating sphere 402.

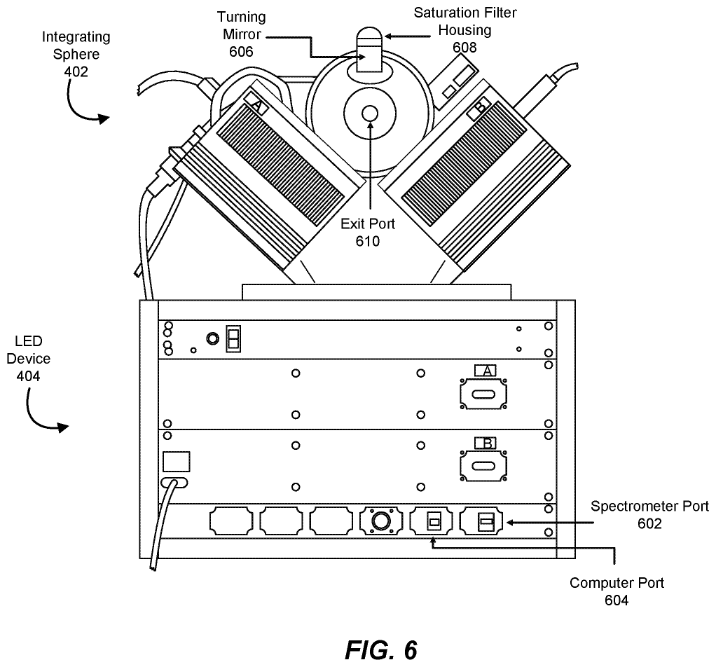

In some embodiments, an LED device and integrated sphere assembly may have various features that facilitate the projection of light with predetermined characteristics, such as specific colors and/or intensities of light. For example, as illustrated in FIG. 6, LED device 404 may include a spectrometer port 602 that enables connection to a spectrometer for calibration of LED device 404. Additionally, LED device 404 may include a computer port 604 that enables connection to a computing device for the transmission of data and/or instructions (e.g., about what color, luminance, and/or intensity of light to project, etc.). In one embodiment, either or both of these ports may be universal series bus (USB) ports. Similarly, integrating sphere 402 may include various features, such as a turning mirror 606 and/or a saturation filter housing 608 capable of housing a saturation filter, either of both of which may affect the color, intensity, and/or direction of light that exits an exit port 610 in integrating sphere 402 and is projected through a reticle and/or lens assembly onto a colorimeter.

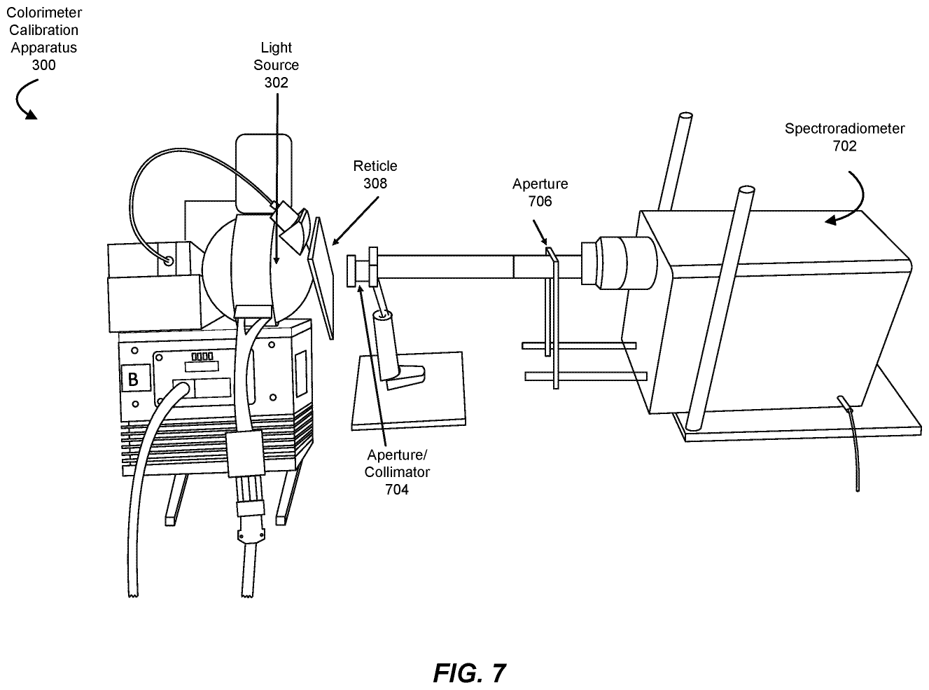

In some embodiments, a colorimeter calibration apparatus may be configured to be modular such that the apparatus can be partially disassembled to enable the apparatus to be calibrated and/or measured in order to increase the accuracy of the calibration of colorimeters. For example, as illustrated in FIG. 7, a colorimeter calibration apparatus 300 may measure various characteristics of a reticle 308 and/or light source 302 via a spectroradiometer 702 by projecting light from light source 302 through reticle 308, though an aperture/collimator 704 and an aperture 706 to spectroradiometer 702. In some examples, spectroradiometer 702 may temporarily replace a lens assembly and/or colorimeter holder while colorimeter calibration apparatus 300 is being measured and/or calibrated based on data gathered by spectroradiometer 702.

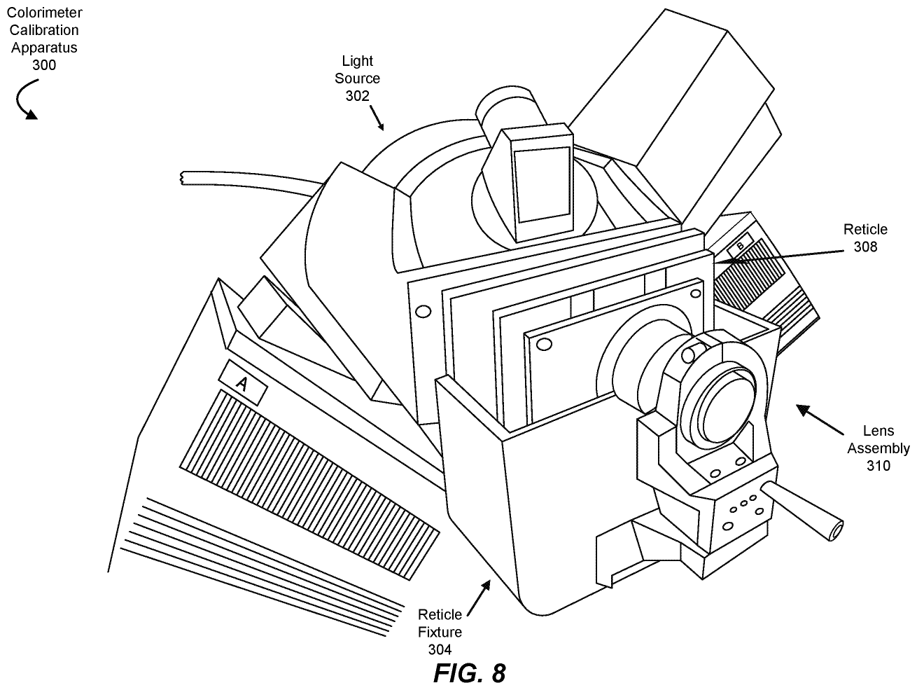

The systems described herein may calibrate and/or otherwise prepare the colorimeter calibration apparatus in a variety of ways. For example, as illustrated in FIG. 8, a technician may install reticle fixture 304 on light source 302, place reticle 308 into reticle fixture 304, making sure the clear square is at top. Next, the technician may turn on the light source 302 green channel and check the alignment between reticle 308 and reticle fixture 304, making sure the light from light source 302 can pass through the clear square on reticle 308. The technician may then take out reticle 308, rotate reticle 308 clockwise by 90 degrees and place reticle 308 back into reticle fixture 304. Next, a technician may place a colorimeter in front of lens assembly 310 (e.g., colorimeter 314 in FIG. 3) and roughly align the colorimeter aperture with the center of the lens of lens assembly 310. The technician may then turn on light source 302 green channel and capture images with the colorimeter. In some examples, the technician may fine tune the micro stage on lens assembly 310 (e.g., micrometer stage 312 in FIG. 3) until a sharp checkerboard image (e.g., positive checkerboard 206 in FIG. 2) can be seen projected through reticle 308 into the colorimeter. In some examples, the technician may adjust the cant and/or tilt angle of the colorimeter to make sure the checker of the checkerboard is aligned with the center of the camera sensor.

In some examples, after aligning the colorimeter in the colorimeter calibration apparatus, a technician may then begin the measurement phase of colorimeter calibration. In some examples, the technician may select the desired neutral density filter and/or color filter in the colorimeter that needs to be calibrated. The technician may then take a series of low exposure and of high exposure images of each pattern on the reticle while projecting each of red, green, and blue light through the reticle onto the colorimeter. After capturing the series of images, the technician and/or an automatic analyzer may analyze the images (e.g., by measuring the luminance and/or noise of each image relative to one another and/or an objective standard) to determine the positive and negative instrument contrast of the colorimeter. In some examples, this process may be repeated with a different neutral density filter and/or color filter.

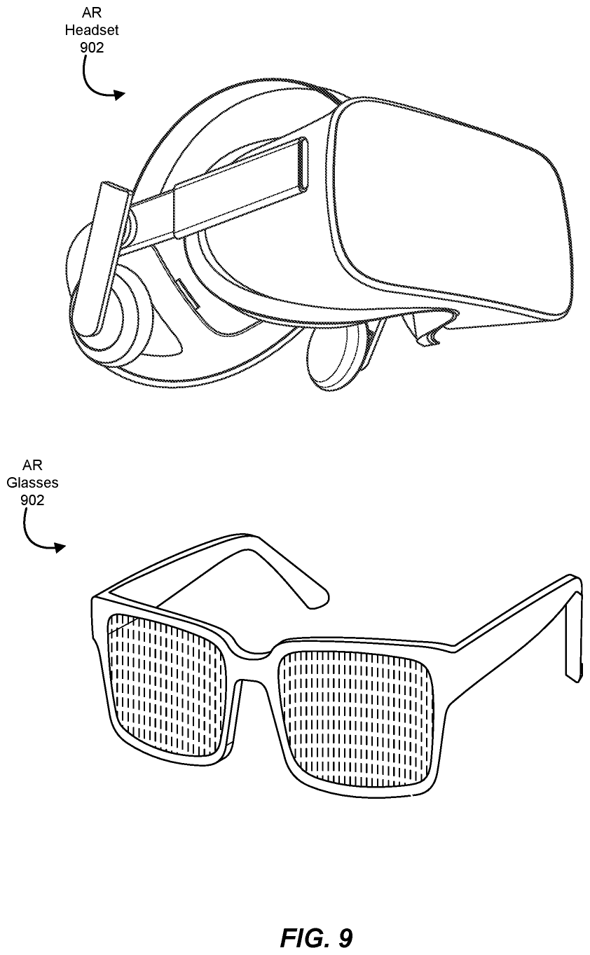

In some embodiments, the systems described herein may calibrate one or more colorimeters that are then used to calibrate AR devices. For example, a colorimeter calibrated by the systems described herein may be used to calibrate a display on an AR headset 902 and/or AR glasses 904 illustrated in FIG. 9.

As described above, the systems and methods described herein may enable highly accurate calibration of colorimeters, resulting in improved color display on the devices calibrated by those colorimeters and, ultimately, an improved end-user experience for the users of those devices. For example, an AR headset calibrated by a colorimeter calibrated by the systems described herein may have more accurate contrast, facilitating an immersive and enjoyable user experience. In some embodiments, the systems described herein may enable efficient calibration of colorimeters by being configured to require minimal re-adjustment in between colorimeter calibrations due to holding the colorimeter steady in a holder and having other components (e.g., a reticle holder, lens assembly, etc.) affixed to one another such that the components do not move relative to one another when colorimeters are swapped out and/or the entire apparatus is moved. This configuration may improve the effectiveness and efficiency of technicians calibrated colorimeters, leading to improved overall outcomes.

### EXAMPLE EMBODIMENTS

Example 1: A colorimeter calibration apparatus may include a uniform luminance light source that projects light with at least one predetermined characteristic and a reticle holder that is affixed to the uniform luminance light source and that holds a removable reticle through which the light is projected.

Example 2: The colorimeter calibration apparatus of example 1, where the at least one predetermined characteristic of the light includes a color of the light.

Example 3: The colorimeter calibration apparatus of examples 1-2, where the at least one predetermined characteristic of the light includes at least one of a uniform luminance and an intensity of the light.

Example 4: The colorimeter calibration apparatus of examples 1-3 may further include a lens through which the light is projected, where the lens is affixed to the reticle holder.

Example 5: The colorimeter calibration apparatus of examples 1-4, where the reticle holder is configured to hold any of a set of multiple removable reticles with different openings.

Example 6: A system for colorimeter calibration may include a uniform luminance light source that projects light with at least one predetermined characteristic, a removable reticle that includes a reticle image through which the light is projected, a reticle holder that is affixed to the uniform luminance light source and that holds the removable reticle, and an imaging lens through which the reticle image is projected onto a colorimeter to be calibrated.

Example 7: The system of example 6, where the removable reticle includes a plurality of openings through which the light is projected that each include a distinct pattern.

Example 8: The system of examples 6-7, where the plurality of openings include a checkboard pattern, an inverted checkboard pattern that is the inverse of the checkerboard pattern that includes light checkers and dark checkers, a solid grey pattern with an optical transmission identical to that of the dark checkers in the checkerboard pattern, and a transparent pattern.

Example 9: The system of examples 6-8, where the removable reticle includes one of a set of removable reticles, where each reticle within the set of removable reticles includes a different opening that is configured to be placed in the reticle holder.

Example 10: The system of examples 6-9 may further include a lens through which the light is projected, where the lens is affixed to the reticle holder.

Example 11: The system of examples 6-10, where the at least one predetermined characteristic of the light includes a color of the light.

Example 12: The system of examples 6-11, where the at least one predetermined characteristic of the light includes at least one of a uniform luminance and an intensity of the light.

Example 13: The system of examples 1-12 may further include a colorimeter holder that is affixed to the reticle holder and that holds a colorimeter such that the uniform luminance light source projects the light through the reticle and onto the colorimeter.

Example 14: A method for calibrating colorimeters may include temporarily affixing a colorimeter to be calibrated to a colorimeter calibration apparatus that includes a uniform luminance light source affixed to a reticle holder, inserting a removable reticle into the reticle holder, projecting a light from the uniform luminance light source through an opening in the removable reticle onto the colorimeter, and measuring the light that reaches the colorimeter after passing through the opening.

Example 15: The method of example 14 may further include rotating the removable reticle to align a different opening with the colorimeter and measuring the light that reaches the colorimeter after passing through the different opening.

Example 16: The method of examples 14-15, where rotating the removable reticle includes rotating the removable reticle ninety degrees.

Example 17: The method of examples 14-16 may further include removing the removable reticle from the reticle holder, inserting, into the reticle holder, a new removable reticle with a new opening not found in the removable reticle, and measuring the light that reaches the colorimeter after passing through the new opening.

Example 18: The method of examples 14-17, where the light includes a light of a specific color and further including projecting a light of a different color from the uniform luminance light source through the opening in the removable reticle onto the colorimeter and measuring the light of the different color that reaches the colorimeter after passing through the opening.

Example 19: The method of examples 14-18, where the removable reticle includes four openings through which the light is projected that each include a distinct pattern.

Example 20: The method of examples 14-19, where four openings include a checkboard pattern that includes light checkers and dark checkers, an inverted checkboard pattern that is the inverse of the checkerboard pattern, a solid grey pattern with an optical transmission identical to that of the dark checkers in the checkerboard pattern, and a transparent pattern.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A colorimeter calibration apparatus comprising:
a uniform luminance light source that projects light with at least one predetermined characteristic; and
a reticle holder that is affixed to the uniform luminance light source and that holds a removable reticle through which the light is projected.

2. The colorimeter calibration apparatus of claim 1, wherein the at least one predetermined characteristic of the light comprises a color of the light.

3. The colorimeter calibration apparatus of claim 1, wherein the at least one predetermined characteristic of the light comprises at least one of a uniform luminance and an intensity of the light.

4. The colorimeter calibration apparatus of claim 1, further comprising a lens through which the light is projected, wherein the lens is affixed to the reticle holder.

5. The colorimeter calibration apparatus of claim 1, wherein the reticle holder is configured to hold any of a set of multiple removable reticles with different openings.

6. A system comprising:
a uniform luminance light source that projects light with at least one predetermined characteristic;
a removable reticle that comprises at least one reticle image through which the light is projected;
a reticle holder that is affixed to the uniform luminance light source and that holds the removable reticle; and
an imaging lens through which the reticle image is projected onto a colorimeter to be calibrated.

7. The system of claim 6, wherein the removable reticle comprises a plurality of openings through which the light is projected that each comprise a distinct pattern.

8. The system of claim 7, wherein the plurality of openings comprise:
a checkboard pattern that comprises dark checkers and light checkers;
an inverted checkboard pattern that is the inverse of the checkerboard pattern;
a solid grey pattern with an optical transmission identical to that of the dark checkers in the checkerboard pattern; and
a transparent pattern.

9. The system of claim 6, wherein the removable reticle comprises one of a set of removable reticles, wherein each reticle within the set of removable reticles comprises a different opening that is configured to be placed in the reticle holder.

10. The system of claim 6, further comprising a lens through which the light is projected, wherein the lens is affixed to the reticle holder.

11. The system of claim 6, wherein the at least one predetermined characteristic of the light comprises a color of the light.

12. The system of claim 6, wherein the at least one predetermined characteristic of the light comprises at least one of a uniform luminance and an intensity of the light.

13. The system of claim 6, further comprising a colorimeter holder that is affixed to the reticle holder and that holds a colorimeter such that the uniform luminance light source projects the light through the reticle and onto the colorimeter.

14. A method comprising:
temporarily affixing a colorimeter to be calibrated to a colorimeter calibration apparatus that comprises a uniform luminance light source affixed to a reticle holder;
inserting a removable reticle into the reticle holder;
projecting a light from the uniform luminance light source through an opening in the removable reticle with an imaging lens onto the colorimeter; and
measuring the light that reaches the colorimeter after passing through the opening.

15. The method of claim 14, further comprising:
rotating the removable reticle to align a different opening with the colorimeter; and
measuring the light that reaches the colorimeter after passing through the different opening.

16. The method of claim 15, wherein rotating the removable reticle comprises rotating the removable reticle ninety degrees.

17. The method of claim 14, further comprising:
removing the removable reticle from the reticle holder;
inserting, into the reticle holder, a new removable reticle with a new opening not found in the removable reticle; and
measuring the light that reaches the colorimeter after passing through the new opening.

18. The method of claim 14:
wherein the light comprises a light of a specific color;
further comprising:
projecting a light of a different color from the uniform luminance light source through the opening in the removable reticle with an imaging lens onto the colorimeter; and
measuring the light of the different color that reaches the colorimeter after passing through the opening.

19. The method of claim 14, wherein the removable reticle comprises four openings through which the light is projected that each comprise a distinct pattern.

20. The method of claim 19, wherein the four openings comprise:
a checkboard pattern that comprises dark checkers and light checkers;
an inverted checkboard pattern that is the inverse of the checkerboard pattern;
a solid grey pattern with an optical transmission identical to that of the dark checkers in the checkerboard pattern; and
a transparent pattern.
